(19) United States
(12) Patent Application Publication
(10) Pub. No.: US 2006/0277884 A1
(43) Pub. Date: Dec. 14, 2006

(54) Object detection system for a lawn mower

(75) Inventor: Corey W. Bucher, Wrightstown, WI (US)

Correspondence Address: MICHAEL BEST & FRIEDRICH, LLP, 100 E WISCONSIN AVENUE, MILWAUKEE, WI, 53202, US

(73) Assignee: Ariens Company, Brillion, WI (US)

(21) Appl. No.: 11/149,497

(22) Filed: Jun. 10, 2005

(51) Int. Cl. A01D 41/127

(52) U.S. Cl. 56/10.2 R

(57) ABSTRACT

An object detection system is operable to alert and/or automatically react to a lawn mower, or equivalent mower equipment, contacting an object when the lawn mower is operating in reverse gear. The object detection system comprises a sensor strip, a connection lead wire and an electrical circuit. The sensor strip generates and electrical contact signal traveling through the lead wire in response to the lawn mower contacting an object. The electrical contact signal causes the electrical circuit to enable a warning system and selectively activate a brake system and disable the power take off (PTO) switch to stop rotation of the mower blade.

### BACKGROUND

The present invention relates to an object detection system for a lawn mower.

### SUMMARY

In one embodiment, the invention provides a lawn mower comprising a chassis; a plurality of wheels mounted for rotation with respect to the chassis and supporting the chassis; a mower deck supported by the chassis; a cutting blade beneath the mower deck and rotatable to cut vegetation under the mower deck; an engine supported by the chassis and selectively engaging the wheels to cause forward movement and reverse movement of the lawn mower, and selectively engaging the cutting blade to cause rotation of the blade; means for generating an electrical contact signal in response to a rear portion of the lawn mower contacting an object; and an electrical circuit causing the mower blade to cease rotation in response to receiving the electrical contact signal.

In another embodiment the invention provides a method for operating a lawn mower comprising of a chassis, a plurality of wheels, a mower deck, a cutting blade, and an engine. The method comprises (a) applying a pressure sensor to a rear portion of the lawn mower; (b) generating an electrical signal in response to the pressure sensor detecting impact with an object; (c) transmitting the electrical contact signal to an electrical circuit; and (d) stopping rotation of the mower blade in response to the electrical circuit receiving the electrical contact signal.

The electrical circuit may disengage the mower blade from the engine in response to receiving the electrical contact signal, or it may shut down the engine in response to receiving the electrical contact signal. The lawn mower may also include a bumper in the rear portion of the lawn mower, and the means for generating the electrical contact signal may be mounted on the bumper. The lawn mower may also include a braking system for selectively resisting rotation of the cutting blade, and the electrical circuit may activate the braking system in response to the electrical circuit receiving the electrical contact signal.

The means for generating the electrical contact signal may take the form of, for example, a resilient strip with pressure sensors. The electrical circuit may include a relay that permits the engine to engage the cutting blade in the absence of the electrical contact signal, but that disengages the cutting blade from the engine in response to receiving the electrical contact signal. The electrical circuit may also include a central processing unit (CPU) to filter out transient electrical signals. The means for generating the electrical contact signal may also include a wireless transmitter and receiver.

Other aspects of the invention will become apparent by consideration of the detailed description and accompanying drawings.

### BRIEF DESCRIPTION OF THE DRAWINGS

FIG. I is a perspective view of a lawn mower embodying the present invention.

FIG. 2 is an exploded view of the rear portion of the lawn mower.

FIG. 3 is a schematic illustration of the electrical circuit of the lawn mower in a blade-disengaged condition.

FIG. 4 is a schematic illustration of the electrical circuit of the lawn mower in a blade-engaged condition.

FIG. 5 is a schematic illustration of the electrical circuit of the lawn mower in a blade-disabled condition.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

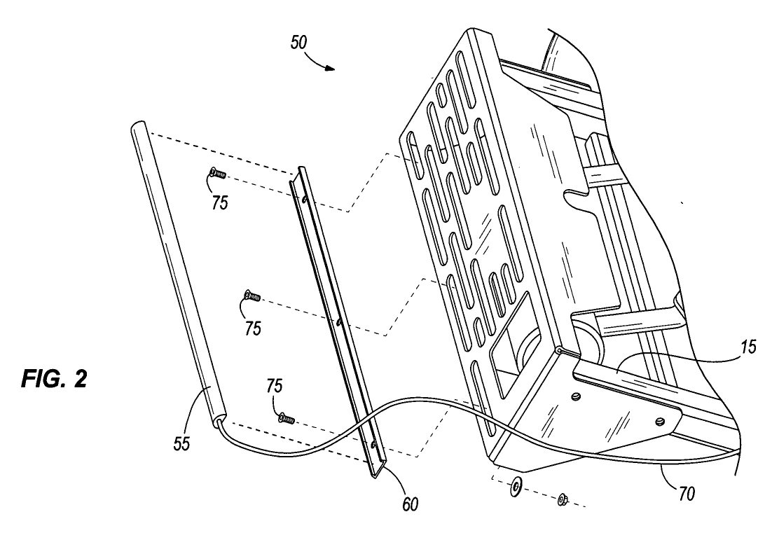

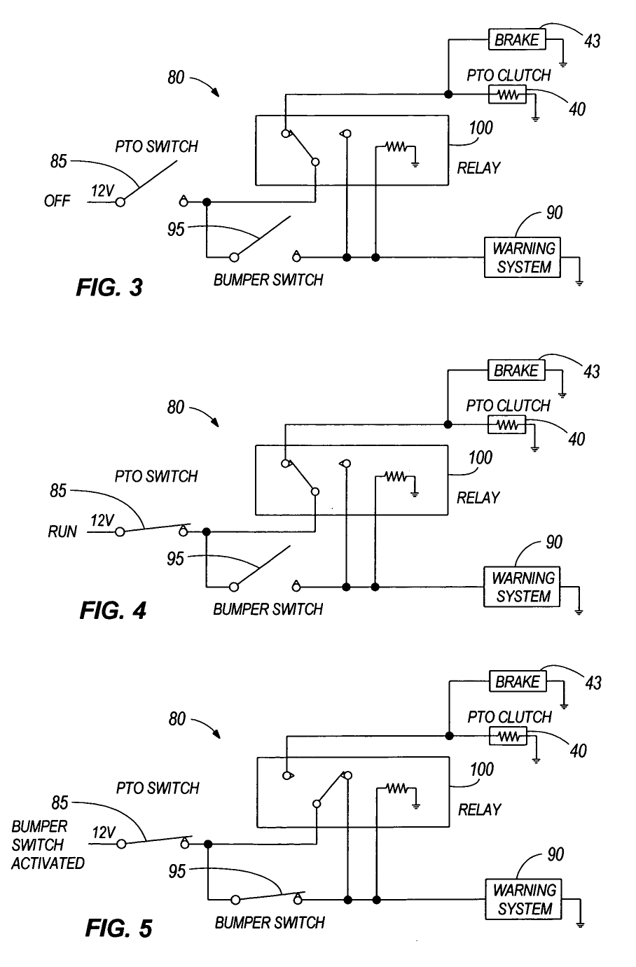

FIG. 1 illustrates a lawn mower 10 comprising a chassis 15, a mower deck 20, one or more cutting blades 25 beneath the mower deck 20, a set of four wheels 30 supporting the chassis 15, and an engine 35. A power take off (PTO) clutch 40 (illustrated schematically in FIGS. 3-5) selectively engages the cutting blade 25 to the output shaft 45 of the engine 35 to cause the cutting blade 25 to rotate under the influence of the engine 35. A brake 43 (illustrated schematically in FIGS. 3-5) selectively stops rotation of the blades 25 so they do not continue to rotate after the engine is disengaged from the blades. Although the illustrated lawn mower is of the zero-turn, transteer variety, the invention may also be embodied in more traditional lawn tractors or any other type of riding lawn mower.

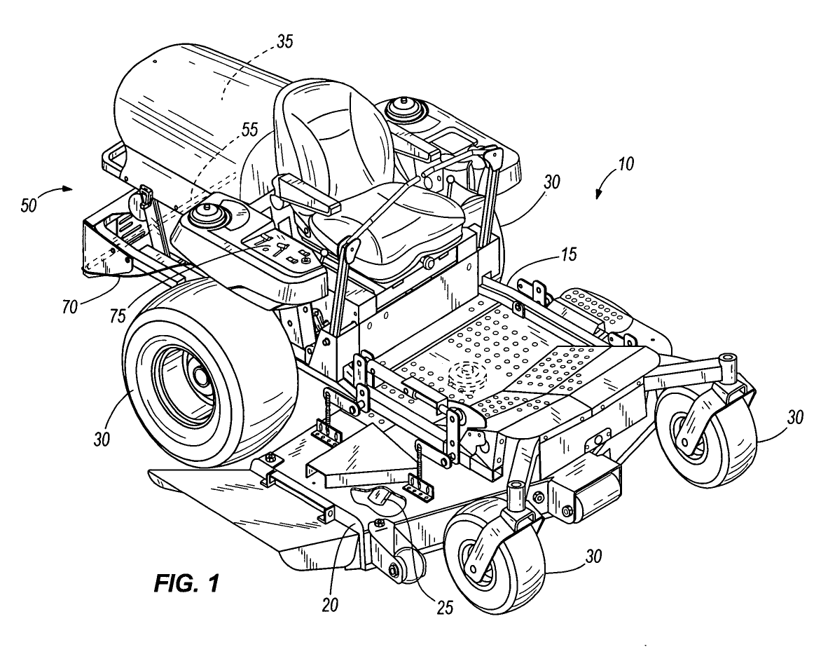

FIG. 2 illustrates a rear portion 50 of the lawn mower 10, which includes a pressure sensor strip 55 mounted within a bracket 60 that is fastened to a rear portion of the chassis 15 using screws 75 or other appropriate fasteners or mounting means. Alternatively, the lawn mower 10 can include a bumper mounted to the rear portion of the chassis 15 and the strip 55 can be affixed to the bumper. In the illustrated embodiment, the strip 55 is a product commercially available from Recon Company of Batavia, Ill., and sold as part number T-120 under registered trademark SENSI-SWITCH. More specifically, the strip 55 comprises a high yield stainless steel electrode acting as sensing element. The electrode is molded in urethane and electrically communicates with a lead wire 70. In operation, the electrode generates an electrical contact signal in response to pressure being applied to the strip 55, and the lead wire 70 conducts the electrical contact signal.

The lead wire 70 is connected to the lawn mower's electrical system 75. The electrical system may include, for example, a battery, a lighting system, a start up system, control panel with switches and lights, steering control system, and other elements. In some embodiments, the electrical system may include controllers and circuits such as that disclosed in commonly-assigned U.S. Patent Application Publication No. 2005-0053447 A1, the entire contents of which are incorporated herein by reference.

FIGS. 3-5 illustrate an electrical circuit 80 that is also part of the lawn mower's electrical system. The electrical circuit 80 includes a PTO switch 85, which a user can actuate to engage the PTO clutch 40 and cause rotation of the cutting blade 25 under the influence of the engine 35. The circuit 80 also includes a warning system 90, which alerts the user when the rear portion 50 of the lawn mower comes into contact with an object. The circuit 80 also includes a bumper switch 95, which closes in response to receiving the electrical contact signal from the strip 55. Last, the circuit 80 includes a relay system 100, which is connected to the PTO switch 85, the PTO clutch 40, the bumper switch 95 and the warning system 90.

FIG. 3 illustrates the electrical circuit 80 when the cutting blade 25 is not engaged to the engine 35. During normal operation of the lawn mower 10, the engine 35 of the lawn mower 10 is operating but the engine 35 does not engage the cutting blade 25 until the PTO switch 85 is closed by the user.

FIG. 4 illustrates the PTO switch 85 in a closed position, therefore the PTO clutch 40 becomes part of a closed electrical circuit and causes the engine 35 to engage the cutting blade 25. During such normal operation of the lawn mower 10, the bumper switch 95 remains open, keeping the warning system 90 off.

FIG. 5 illustrates the operation of the electrical circuit 80 when the strip 55 generates the electrical contact signal. The bumper switch 95 closes in response to receiving the electrical contact signal. This causes the relay system 100 to switch from connecting the PTO switch 85 to the PTO clutch 40 to connecting the PTO switch 85 to the warning system 90. As a result, the cutting blade 25 disengages from the engine 35 while the warning system 90 starts operation. The circuit 80 can perform other acts in response to receiving the electrical contact signal, such as shut down the engine 35, automatically shifting the transmission into a neutral or forward gear, and engaging the blade brake 43.

With respect to the blade, the relay system 100 may connect the PTO switch 85 to the brake 43 in response to the bumper switch 95 closing. In consequence, the brake stops the rotational motion of the cutting blade 25 as the cutting blade 25 disengages from the engine 35.

In alternative embodiments, the electrical circuit 80 may include a central processing unit (CPU) that controls operation of the mower blade 25 in response to actuation of the PTO switch 85 and generation of the electrical contact signal at the pressure sensor strip 55. In some embodiments, the electrical circuit 80 can include wireless means for transferring the electrical contact signal, including wireless receivers and transmitters. Also, the CPU may be programmed to filter out transient contacts. Transient contacts may include, for example, electrical contact signals produced by the strip 55 due to contacting objects such as flying rocks and flying chips, other flying debris, or high grass during normal operation of the lawn mower.

Thus, the invention provides, among other things, an object detection system for a lawn mower. Various features and advantages of the invention are set forth in the following claims.

What is claimed is:

1. A lawn mower comprising:
a chassis;
a plurality of wheels mounted for rotation with respect to the chassis and supporting the chassis;
a mower deck supported by the chassis;
a cutting blade beneath the mower deck and rotatable to cut vegetation under the mower deck;
an engine supported by the chassis and selectively engaging the wheels to cause forward movement and reverse movement of the lawn mower, and selectively engaging the cutting blade to cause rotation of the blade;
means for generating an electrical contact signal in response to a rear portion of the lawn mower contacting an object; and
an electrical circuit causing the mower blade to cease rotation in response to receiving the electrical contact signal.

2. The lawn mower of claim 1, wherein the electrical circuit disengages the mower blade from the engine in response to receiving the electrical contact signal.

3. The lawn mower of claim 1, wherein the electrical circuit shuts down the engine in response to receiving the electrical contact signal.

4. The lawn mower of claim 1, further comprising of a bumper in the rear portion of the lawn mower, wherein the means for generating is mounted on the bumper.

5. The lawn mower of claim 1, further comprising a braking system for selectively resisting rotation of the cutting blade, wherein the electrical circuit activates the braking system in response to the electrical circuit receiving the electrical contact signal.

6. The lawn mower of claim 1, wherein the means for generating includes a resilient strip with pressure sensors.

7. The lawn mower of claim 1, wherein the electrical circuit includes a relay that permits the engine to engage the cutting blade in the absence of the electrical contact signal, but that disengages the cutting blade from the engine in response to receiving the electrical contact signal.

8. The lawn mower of claim 1, wherein the electrical circuit includes a central processing unit (CPU) to filter out transient electrical signals.

9. The lawn mower of claim 1, wherein the means for generating includes a wireless transmitter and the electrical circuit includes a wireless receiver.

10. A lawn mower comprising:
a chassis;
a plurality of wheels mounted for rotation with respect to the chassis and supporting the chassis;
a mower deck supported by the chassis;
a cutting blade beneath the mower deck and rotatable to cut vegetation under the mower deck;
an engine supported by the chassis and selectively engaging the wheels to cause forward movement and reverse movement of the lawn mower, and selectively engaging the cutting blade to cause rotation of the blade;
a pressure sensor generating an electrical contact signal in response to a rear portion of the lawn mower contacting an object; and
an electrical circuit causing the mower blade to cease rotation in response to receiving the electrical contact signal.

11. The lawn mower of claim 10, wherein the electrical circuit disengages the mower blade from the engine in response to receiving the electrical contact signal.

12. The lawn mower of claim 10, wherein the electrical circuit shuts down the engine in response to receiving the electrical contact signal.

13. The lawn mower of claim 10, further comprising of a bumper in the rear portion of the lawn mower, wherein the pressure sensor is mounted on the bumper.

14. The lawn mower of claim 10, further comprising of a braking system for selectively resisting rotation of the cutting blade, wherein the electrical circuit activates the braking system in response to the electrical circuit receiving the electrical contact signal.

15. The lawn mower of claim 10, wherein the pressure sensor is enclosed within a resilient strip.

16. The lawn mower of claim 10, wherein the electrical circuit includes a relay that permits the engine to engage the cutting blade in the absence of the electrical contact signal, but that disengages the cutting blade from the engine in response to receiving the electrical contact signal.

17. The lawn mower of claim 10, wherein the electrical circuit includes a central processing unit (CPU) to filter out transient electrical signals.

18. The lawn mower of claim 10, wherein the pressure sensor connects to a wireless transmitter and the electrical circuit includes a wireless receiver.

19. A method for operating a lawn mower comprising of a chassis, a plurality of wheels, a mower deck, a cutting blade, and an engine, the method comprising:
(a) applying a pressure sensor to a rear portion of the lawn mower;
(b) generating an electrical signal in response to the pressure sensor detecting impact with an object;
(c) transmitting the electrical signal to an electrical circuit; and
(d) stopping rotation of the mower blade in response to the electrical circuit receiving the electrical signal.

20. The method of claim 19, wherein the rear portion of the lawn mower includes a bumper, and wherein step (a) includes applying the pressure sensor to the bumper.

21. The method of claim 19, wherein the pressure sensor is connected to a wireless transmitter, the electrical circuit includes a wireless receiver, and wherein step (c) includes sending a signal from the wireless transmitter to the wireless receiver.

22. The method of claim 19, wherein the lawn mower includes a braking system, and wherein step (d) includes stopping the mower blade with the braking system.

23. The method of claim 19, wherein the electrical system includes a relay system, and step (d) includes disengaging the cutting blade from the engine with the relay system.
